(19) United States
(12) Patent Application Publication
(10) Pub. No.: US 2020/0154524 A1
(43) Pub. Date: May 14, 2020

(54) ELECTRICAL RESISTOR, HONEYCOMB STRUCTURE AND ELECTRICALLY HEATED CATALYST DEVICE

(71) Applicant: DENSO CORPORATION, Kariya-city (JP)

(72) Inventors: Takehiro TOKUNO, Kariya-city (JP); Junichi NARUSE, Kariya-city (JP); Kazuki HIRATA, Kariya-city (JP); Mika KAWAKITA, Kariya-city (JP); Yasushi TAKAYAMA, Kariya-city (JP)

(21) Appl. No.: 16/728,261

(22) Filed: Dec. 27, 2019

Related U.S. Application Data
(63) Continuation of application No. PCT/JP2018/023137, filed on Jun. 18, 2018.

(30) Foreign Application Priority Data
Jun. 30, 2017 (JP) 2017-129229
Dec. 19, 2017 (JP) 2017-243080

(51) Int. Cl. H05B 3/14; C04B 35/195; F01N 3/20

(52) U.S. Cl. CPC H05B 3/141; F01N 3/20; C04B 35/195

(57) ABSTRACT

An electrical resistor comprises a matrix composed of borosilicate containing at least one kind of alkali group atoms selected from the group consisting of Na, Mg, K, Ca, Li, Be, Rb, Sr, Cs, Ba, Fr, and Ra. The electrical resistor preferably has an electroconductive filler. A honeycomb structure comprises the electrical resistor. An electrically heated catalyst device comprises the honeycomb structure. The electrical resistor preferably has an electrical resistivity in a range from 0.0001 to 1 Ω·m and an electrical resistance increase rate in a range from 0.01×10⁻⁶ to 5.0×10⁻⁴/K in a temperature range from 25° C. to 500° C.

### CROSS-REFERENCE TO RELATED APPLICATION

This application is a U.S. application under 35 U.S.C. 111(a) and 363 that claims the benefit under 35 U.S.C. 120 from International Application No. PCT/JP2018/023137 filed on Jun. 18, 2018, the entire contents of which are incorporated herein by reference. This application is also based on and claims the benefit of priority from earlier Japanese Patent Application No. 2017-129229 filed Jun. 30, 2017, and Japanese Patent Application No. 2017-243080 filed Dec. 19, 2017, the descriptions of which are incorporated herein by reference.

### BACKGROUND

### Technical Field

The present disclosure relates to an electrical resistor, a honeycomb structure and an electrically heated catalyst device.

### Background Art

Conventionally, electrical resistors have been used in electric heating in various fields. For example, in the field of vehicles, electrically heated catalyst devices are publicly known where honeycomb structures carrying catalysts are composed of electrical resistors of SiC and the like, and the honeycomb structures are heated by electric heating.

### SUMMARY

An embodiment of the present disclosure is an electrical resistor comprising a matrix composed of borosilicate containing at least one kind of alkali group atoms selected from the group consisting of Na, Mg, K, Ca, Li, Be, Rb, Sr, Cs, Ba, Fr, and Ra.

### BRIEF DESCRIPTION OF THE DRAWINGS

The above object and other objects, features and advantages of the present disclosure shall become clearer by the following detailed description with reference to the accompanying drawings. The drawings are as follows:

FIG. 1 is an explanatory view schematically showing a microstructure of an electrical resistor of Embodiment 1.

FIG. 2 is an explanatory view schematically showing a microstructure of an electrical resistor of Embodiment 2.

FIG. 3 is an explanatory view schematically showing a honeycomb structure of Embodiment 3.

FIG. 4 is an explanatory view schematically showing an electrically heated catalyst device of Embodiment 4.

FIG. 5 is a graph showing the relationship between temperature and electrical resistivity of each of sample 1 and sample 2, in Experimental Example 1.

FIG. 6 is a graph showing the relationship between temperature and electrical resistivity of each of sample 2 and sample 1C in Experimental Example 1.

FIG. 7 is a graph showing the relationship between addition ratio of sodium carbonate and electrical resistivity of samples in Experimental Example 2.

FIG. 8 shows (a) an atom mapping image of aluminum of sample 2, and (b) an optical microscope image of a peripheral of an emission portion in Experimental Example 3.

FIG. 9 shows an atom mapping image of aluminum of a peripheral of an emission portion of sample 2 in Experimental Example 4.

FIGS. 10(a)-(e) show composition analysis results by SEM-EDX of sample 2 in Experimental Example 5.

FIG. 11 is a graph showing the relationship between temperature and electrical resistivity of each of sample 6 and sample 7 in Experimental Example 6.

FIG. 12 shows atom mapping images of cross-sections of a material of sample 6 in Experimental Example 6.

FIG. 13 shows atom mapping images of cross-sections of a material of sample 7 in Experimental Example 6.

FIG. 14 is a line profile of Ca in the depth direction from the surface of a material of sample 6 in Experimental Example 6.

FIG. 15 is a line profile of Ca in the depth direction from the surface of a material of sample 7 in Experimental Example 6.

FIG. 16 is a graph showing the relationship between temperature and electrical resistivity of samples 8 and sample 9 (products calcined at 1250° C.) in Experimental Example 7.

FIG. 17 is a graph showing the relationship between temperature and electrical resistivity of sample 10 to sample 12 (products calcined at 1300° C.) in the Experimental Example 7.

### DETAILED DESCRIPTION OF THE PREFERRED EMBODIMENTS

Hereinafter, embodiments will be described with reference to the drawings.

JP 2004-131302 A discloses an electroconductive ceramic obtained by adding water to a powder mixture comprising 20 to 35 wt % of metal Si powder, 5 to 15 wt % of quartz powder, 20 to 30 wt % of borosilicate glass and 30 to 40 wt % of clay powder followed by kneading and molding, and then by heat treatment at a temperature of 1,200 to 1,300° C. under the atmosphere.

In this connection, in order for the electrical resistor to be efficiently heated by electric heating, there is an optimum value of the current voltage with respect to the electrical resistivity of the electrical resistor. However, as represented by SiC, in many electrical resistors, the temperature dependency of the electrical resistivity is large, and the optimum value of the current voltage changes with the temperature of the electrical resistor. As such, an electrical resistor with a small temperature dependency of electrical resistivity is required.

When the electrical resistivity of an electrical resistor greatly changes with temperature, for example, in a constant voltage controlled electrical circuit, the fluctuation range of a current flowing through the electrical resistor becomes large. Thus, the electrical circuit becomes complicated in order to avoid this, and the cost of the electrical circuit increases. In the case of an electrical resistor that exhibits an NTC characteristic, such as SiC, where the temperature change of the electrical resistivity is large and the electrical resistivity decreases as the temperature increases, a concentrated current flows during electric heating through a portion, etc. where the distance between the electrodes is short, and locally generates heat. Therefore, an electrical resistor exhibiting an NTC characteristic tends to generate a temperature distribution. When a temperature distribution is generated in the electrical resistor, a thermal expansion difference develops in the interior of the electrical resistor, and the electrical resistor is likely to crack. Further, the characteristic that the electrical resistivity increases as the temperature rises is called a PTC characteristic.

The present disclosure intends to provide an electrical resistor where temperature dependency of electrical resistivity is small and the electrical resistivity exhibits a PTC characteristic, or the temperature dependency of electrical resistivity is hardly present, a honeycomb structure using the electrical resistor, and an electrically heated catalyst device using the honeycomb structure.

An embodiment of the present disclosure is an electrical resistor comprising a matrix composed of borosilicate containing at least one kind of alkali group atoms selected from the group consisting of Na, Mg, K, Ca, Li, Be, Rb, Sr, Cs, Ba, Fr, and Ra.

Another embodiment of the present disclosure is a honeycomb structure comprising the electrical resistor.

Still another embodiment of the present disclosure is an electrically heated catalyst device having the honeycomb structure.

### Advantageous Effects of the Invention

The electrical resistor comprises a matrix composed of borosilicate containing at least one kind of alkali group atoms selected from the group consisting of Na, Mg, K, Ca, Li, Be, Rb, Sr, Cs, Ba, Fr, and Ra.

According to the electrical resistor mentioned above, the region that controls electrical resistance during electric heating is the matrix that is a base material. In the matrix, the temperature dependency of the electrical resistivity is smaller than that of SiC, and the electrical resistivity exhibits a PTC characteristic. Thus, in the case where the electrical resistivity of another substance different from the matrix that can be included in the electrical resistor exhibits a PTC characteristic, the electrical resistivity of the electrical resistor has a small temperature dependency and can exhibit a PTC characteristic. On the other hand, in the case where the electrical resistivity of the other substance exhibits an NTC characteristic, the electrical resistivity of the electrical resistor can be designed so that the temperature dependency is small and exhibits a PTC characteristic, or the temperature dependency is hardly present, by adding together the electrical resistivity of a matrix exhibiting a PTC characteristic and the electrical resistivity of the other substance exhibiting an NTC characteristic.

Therefore, according to the electrical resistor, by adopting the matrix, an electrical resistor where temperature dependency of electrical resistivity is small and electrical resistivity exhibits a PTC characteristic, or the temperature dependency of electrical resistivity is hardly present.

In addition, as described above, the electrical resistor can be composed so that the electrical resistivity does not exhibit an NTC characteristic, and therefore it is possible to avoid current concentration during electric heating. Thus, in the electrical resistor, a temperature distribution is unlikely to be generated in the interior, and cracks due to a thermal expansion difference are unlikely to occur. Further, SiC can be heated by electric heating with a small current so that cracks due to a thermal expansion difference do not occur, but it takes time to sufficiently heat the SiC.

Furthermore, in the electrical resistor, by adopting the matrix, it is possible to reduce the electrical resistance of the matrix. Thus, in the case where the electrical resistor contains another substance, for example, by selecting a substance with low electrical resistivity as the other substance and increasing its content, the electrical resistivity of the electrical resistor can be readily reduced. Therefore, the electrical resistor has an advantage of being able to have low electrical resistance and to make the temperature dependency of electrical resistivity small compared to a resistor with its entire bulk composed of the matrix, SiC and the like.

The honeycomb structure comprises the electrical resistor. Thus, in the honeycomb structure, a temperature distribution is unlikely to be generated in the interior of the structure during electric heating, and cracks due to a thermal expansion difference are unlikely to occur. In addition, since the honeycomb structure uses the electrical resistor, it is possible to be heated at a lower temperature and in an early period during electric heating.

The electrically heated catalyst device has the honeycomb structure. Thus, the honeycomb structure is unlikely to crack during electric heating, and the reliability of the electrically heated catalyst device can be improved. In addition, since the electrically heated catalyst device uses the honeycomb structure, the honeycomb structure can be heated at a lower temperature and in an early period during electric heating, which is advantageous for early catalyst activation.

Further, the reference signs in parentheses recited in the claims show corresponding relations with the specific means as described in the embodiments to be mentioned later, and do not limit the technical scope of the present disclosure.

### Embodiment 1

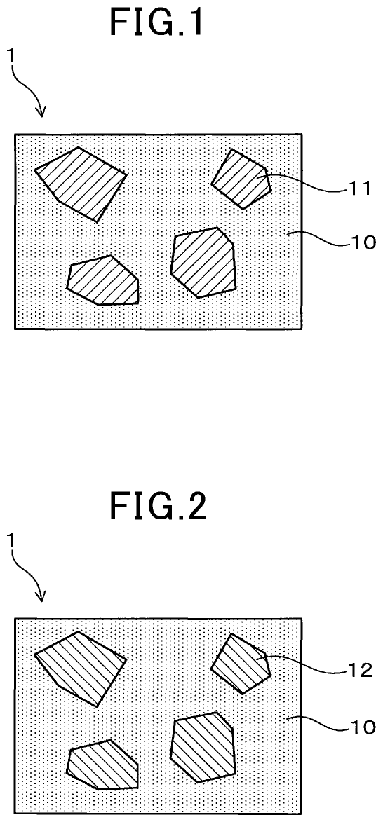

An electrical resistor of Embodiment 1 will now be described using FIG. 1. As illustrated in FIG. 1, an electrical resistor 1 of the present embodiment has a matrix 10. The matrix 10 is a part that constitutes a base material of the electrical resistor 1. Further, the matrix 10 may be amorphous or it may be crystalline.

The matrix 10 is composed of borosilicate containing at least one kind of alkali group atoms selected from the group consisting of Na (sodium), Mg (magnesium), K (potassium), Ca (calcium), Li (lithium), Be (beryllium), Rb (rubidium), Sr (strontium), Cs (cesium), Ba (Barium), Fr (francium), and Ra (radium). Each kind of the alkali group atoms may be contained in the borosilicate alone or in any combination. That is, the borosilicate may contain one kind or more than two kinds of alkali metal atoms, one kind or more than two kinds of alkali earth metal atoms, or a combination thereof. From the perspective of easily gaining low electrical resistance of the matrix 10 and the like, the borosilicate may preferably contain at least one kind of alkali group atoms selected from the group consisting of Na, Mg, K, and Ca. More preferably, the borosilicate may at least contain Na, K, or both Na and K.

In the borosilicate, the total content of alkali group atoms may be 10 mass % or less. According to this composition, it is easy to facilitate the low electrical resistance of the matrix 10. In addition, according to this composition, it is possible to ensure that the matrix 10 has a smaller temperature dependency of the electrical resistivity than that of SiC, and that the electrical resistivity of the matrix exhibits PTC characteristic. Further, in the case where the borosilicate contains one kind of alkali group atoms, the “total content of alkali group atoms” means the mass % of the one kind of alkali group atoms. In addition, in the case where the borosilicate contains more than one kind of alkali group atoms, the “total content of alkali group atoms” means a total content (mass %) obtained by adding up each content (mass %) of each of the more than one kind of alkali group atoms (mass %).

From the perspective of suppressing shape change due to decrease in softening point of the matrix 10 and the like, the total content of alkali group atoms may preferably be 8 mass % or less, more preferably 5 mass % or less, and even more preferably 3 mass % or less. In addition, from the perspective of suppressing formation of an insulating glass film due to segregation of alkali group atoms on the surface side of the electrical resistor 1 during calcining in an oxidizing atmosphere and the like, the total content of alkali group atoms may still more preferably be 2 mass % or less, still further more preferably 1.5 mass %, still even further more preferably 1.2 mass %, and most preferably 1 mass % or less.

Specifically, the borosilicate contains at least one kind of alkali group atoms selected from the group consisting of Na, Mg, K, and Ca, and it may have a composition where the total content of the alkali group atoms is 2 mass % or less. According to this composition, the formation of an insulating glass film due to the elution and segregation of alkali group atoms to the surface side of the electrical resistor 1 and its reaction with the oxygen under the atmosphere is easily suppressed during calcining in an atmosphere containing the oxygen gas even when a gas barrier film that blocks oxygen gas is formed. In addition, in the case of using the electrical resistor 1 as a material for the electroconductive honeycomb structure, it is not necessary to remove the insulating glass film in advance of forming electrodes on the surface of the honeycomb structure, and there is also an advantage of improving the manufacturability of the honeycomb structure. Further, from the perspective of suppressing formation of an insulating glass film and the like, the total content of the alkali group atoms in this case may be preferably 1.5 mass % or less, more preferably 1.2 mass % or less, and even more preferably 1 mass % or less.

However, in the case where oxidation of the electroconductive filler 11 such as Si particles poses a problem, in order to suppress the oxidation of the electroconductive filler 11 by a phenomenon of forming a film on the surface of a material when alkali group atoms are present or by a phenomenon of alkali group atoms encompassing the surroundings of the electroconductive filler 11 such as Si particles to be described later, alkali group atoms may be intentionally added. Therefore, it is important that the total content of the alkali group atoms mentioned above be adequately selected depending on the exertion conditions, using method and the like. However, alkali group atoms are elements that are relatively easily mixed from the raw materials of the electrical resistor 1. As such, it takes cost and time to completely remove the alkali group atoms from the raw materials so that the borosilicate does not contain the alkali group atoms. Therefore, the total content of the alkali group atoms may be preferably 0.01 mass % or more, more preferably 0.05 mass % or more, even more preferably 0.1 mass % or more, and still even more preferably 0.2 mass % or more. Further, in the electrical resistor 1, it becomes possible to reduce the alkali group atoms by using boric acid as a raw material, but not using borosilicate glass containing alkali group atoms. Details shall be described later in experimental examples.

The borosilicate may contain 0.1 mass % or more and 5 mass % or less of B (boron) atoms. According to this composition, there is an advantage that a PTC characteristic is easily exhibited.

From the perspective of making it easier to facilitate low electrical resistance of the matrix 10 and the like, the content of B atoms may be preferably 0.2 mass % or more, more preferably 0.5 mass % or more, even more preferably 1 mass % or more, still even more preferably 1.2 mass % or more, still further more preferably 1.5 mass % or more, and from the perspective that temperature dependency of electrical resistivity is small, electrical resistivity easily exhibits a PTC characteristic and the like, still even further more preferably more than 2 mass %. In addition, there is a limit to the doping amount of B atoms into silicate and, when the B atoms are not doped, the B atoms are unevenly distributed in the material as B₂O₃, which is an insulator, and this causes a decrease in electroconductivity. From the perspective of avoiding this and the like, the content of B atoms may be preferably 4 mass % or less, more preferably 3.5 mass % or less, and even more preferably 3 mass % or less.

The borosilicate may contain 5 mass % or more and 40 mass % or less of Si (silicon) atoms. According to this composition, the electrical resistivity of the borosilicate is likely to exhibit a PTC characteristic.

From the perspective of raising the softening point of the matrix and the like, which ensures exertion of the effect mentioned above, the content of Si atoms may be preferably 7 mass % or more, more preferably 10 mass % or more, and even more preferably 15 mass % or more. In addition, from the perspective of ensuring exertion of the effect mentioned above and the like, the content of Si atoms may be preferably 30 mass % or less, more preferably 26 mass % or less, and even more preferably 24 mass % or less.

The borosilicate may contain 40 mass % or more and 85 mass % or less of O (oxygen) atoms. According to this composition, there is an advantage that PTC characteristic tends to be exhibited.

From the perspective of ensuring exertion of the effect mentioned above and the like, the content of 0 atoms may be preferably 45 mass % or more, more preferably 50 mass % or more, even more preferably 55 mass % or more, and still even more preferably 60 mass % or more. In addition, from the perspective of ensuring exertion of the effect mentioned above and the like, the content of 0 atoms may be preferably 82 mass % or less, more preferably 80 mass % or less, and even more preferably 78 mass % or less.

The borosilicate specifically may be aluminoborosilicate or the like. According to this composition, it is possible to ensure exertion of the electrical resistor 1 where temperature dependency of electrical resistivity is small and electrical resistivity exhibits PTC characteristic, or the temperature dependency of electrical resistivity is hardly present.

In the case where the borosilicate is aluminoborosilicate, the aluminoborosilicate may contain 0.5 mass % or more and 10 mass % or less of Al atoms. From the perspective of ensuring exertion of the effect mentioned above and the like, the content of Al (aluminum) atoms may be preferably 1 mass % or more, more preferably 2 mass % or more, and even more preferably 3 mass % or more. In addition, from the perspective of ensuring exertion of the effect mentioned above and the like, the content of Al atoms may be preferably 8 mass % or less, more preferably 6 mass % or less, and even more preferably 5 mass % or less.

Further, the content of each of the atoms in the borosilicate mentioned above may be selected from the range mentioned above so that the total becomes 100 mass %. In addition, in the case where the borosilicate concurrently meets all the ranges of the total content of alkali group atoms, the content of B atoms, the content of Si atoms, the content of 0 atoms, and the content of Al atoms mentioned above, it is possible to ensure exertion of the electrical resistor 1 where the temperature dependency of the electrical resistivity is small and the electrical resistivity exhibits PTC characteristic, or the temperature dependency of electrical resistivity is hardly present. In addition, examples of atoms that may be contained in the borosilicate composing the matrix 10 may include, besides the ones mentioned above, Fe, C and the like. Further, among the atoms mentioned above, the contents of the alkali group atoms, Si, O, and Al are measured with an electron probe micro analyzer (EPMA). Among the atoms mentioned above, the content of B is measured with an inductively coupled plasma (ICP) analyzer. However, according to ICP analysis, the content of B in the entire electrical resistor 1 is measured, and therefore the obtained measurement result is converted into the content of B in the borosilicate.

The electrical resistor 1 may only have the matrix 10 or may have one kind or two or more kinds of other substances besides the matrix 10. Examples of the other substances may include, among others, a filler, a material that reduces thermal expansion coefficient, a material that raises thermal conductivity, and a material that improves strength.

In the present embodiment, the electrical resistor 1 further comprises an electroconductive filler 11 as illustrated in FIG. 1. According to this composition, by compounding the matrix 10 and the electroconductive filler 11, the electrical resistivity of the matrix 10 and the electrical resistivity of the electroconductive filler 11 are added together, and the electrical resistivity of the entire electrical resistor 1 is determined. Thus, according to this composition, it is possible to control the electrical resistivity of the electrical resistor 1 by adjusting the electroconductivity of the electroconductive filler 11 and the content of the electroconductive filler 11. Further, the electrical resistivity of the electroconductive filler 11 may exhibit either the PTC characteristic or the NTC characteristic, and the temperature dependency of the electrical resistivity may not be present. In addition, as illustrated in FIG. 1, the electrical resistor 1 may have a microstructure of a sea-island structure where the matrix 10 is a sea-like portion and the electroconductive filler 11 is an island-like portion.

Specifically, the electroconductive filler 11 may contain Si atoms. According to this composition, when a raw material containing borosilicate and the electroconductive filler 11 is sintered to produce the electrical resistor 1, the Si atoms of the electroconductive filler 11 diffuse into the borosilicate, and silicon enrichment of the borosilicate is promoted and the softening point of the matrix 10 can be improved. Thus, according to this composition, it is possible to improve the shape retention of the electrical resistor 1, and the electrical resistor 1 that is useful as a material for the structure can be obtained. In particular, a honeycomb structure is a structure having thin cell walls. Therefore, the electrical resistor 1 having the composition mentioned above is useful as a material for an electroconductive honeycomb structure with high structural reliability.

As the electroconductive filler 11 containing Si atoms, those that easily diffuse Si atoms into borosilicate are preferable, and examples thereof include Si particles, Fe—Si based particles, Si—W based particles, Si—C based particles, Si—Mo based particles and Si—Ti based particles. These particles may be used alone or in combination of two or more kinds.

In the case where the electrical resistor has the matrix 10 and the electroconductive filler 11, the electrical resistor 1 specifically may be of a composition containing a total of 50 vol % or more of the matrix 10 and the electroconductive filler 11. Since the electrical resistor 1 employs the matrix 10 composed of the borosilicate mentioned above, electrical resistance of the matrix 10 becomes lower and the matrix 10 also can transmit electrons. According to the composition mentioned above, although it depends on the shape of the electrical resistor 1, the electroconductivity of the electrical resistor 1 can be ensured by publicly known percolation theory. From the perspective of electroconductivity due to formation of percolation and the like, the total content of the matrix 10 and the electroconductive filler 11 is preferably 52 vol % or more, more preferably 55 vol % or more, even more preferably 57 vol % or more, and even further more preferably 60 vol % or more. Further, in the case where the electrical resistor 1 has the matrix 10 and the electroconductive filler 11, electrons flow while propagating through the electroconductive filler 11 and the matrix 10. Further, it is considered that the reason that the electrical resistor 1 exhibits the PTC characteristic is that electrons moving through the electrical resistor 1 are affected by lattice vibration. Specifically, it is estimated that large polarons reported in a substance of NaₓWO₃ and the like are also generated in the electrical resistor 1. It is estimated that, by replacing the position of a tetravalent silicon atom with a trivalent boron, the skeleton of the atom is negatively charged, the electrons of the alkali atom are subjected to a confinement effect, and large polarons are generated.

The electrical resistor 1 may have a composition where a glass film containing alkali group atoms is hardly formed on the surface. According to this composition, in the case of using the electrical resistor 1 as a material for an electroconductive honeycomb structure, it is not necessary to remove the insulating glass film in advance of forming electrodes on the surface of the honeycomb structure, and manufacturability of the honeycomb structure can be improved with certainty. Here, “a glass film containing alkali group atoms is hardly formed on the surface” has the following meaning. Even if a glass film is slightly formed on the surface of the electrical resistor 1, in the case where there is no problem to heat the electrical resistor 1 by electrical heating without removing the glass film when forming electrodes on the surface of the electrical resistor 1, it can be said that the glass film is hardly formed on the surface.

The electrical resistor 1 may have a composition where, in a temperature range from 25° C. to 500° C., the electrical resistivity is in a range of 0.0001 Ω·m or more and 1 Ω·m or less, and the electrical resistance increase rate is in a range of 0.01×10⁻⁶/K or more and 5.0×10⁻⁴/K or less. In addition, the electrical resistor 1 may have a composition where, in a temperature range from 25° C. to 500° C., the electrical resistivity is in a range of 0.0001 Ω·m or more and 1 Ω·m or less, and the electrical resistance increase rate is in a range of 0 or more and less than 0.01×10⁻⁶/K. According to these configurations, a temperature distribution is unlikely to be generated in the interior during electrical heating, and it is possible to ensure exertion of the electrical resistor 1 where cracks due to a thermal expansion difference are unlikely to occur. In addition, according to the configurations mentioned above, the electrical resistor 1 can be heated at a lower temperature and in an early period during electrical heating, and therefore it is useful as a material for a honeycomb structure which is required to be heated in an early period for early catalyst activation. Here, in the case where the electrical resistance increase rate is in a range of 0 or more and less than 0.01×10⁻⁶/K, it can be assumed that the temperature dependency of the electrical resistivity is hardly present.

Although it may be different depending on required specifications of a system using the electrical resistor 1, from the perspective of lowering electrical resistance of the electrical resistor 1 and the like, the electrical resistivity of the electrical resistor 1 may be, for example, preferably 0.5 Ω·m or less, more preferably 0.3 Ω·m or less, even more preferably 0.1 Ω·m or less, still even more preferably 0.05 Ω·m or less, still further more preferably 0.01 Ω·m or less, still even further more preferably less than 0.01 Ω·m, and most preferably 0.005 Ω·m or less. From the perspective of increasing heat generation during electric heating and the like, the electrical resistivity of the electrical resistor 1 may be preferably 0.0002 Ω·m or more, more preferably 0.0005 Ω·m or more, and even more preferably 0.001 Ω·m or more. According to this composition, the electrical resistor 1 preferable for a material of the honeycomb structure used for the electrically heated catalyst device can be obtained.

From the perspective of facilitating suppression of a temperature distribution caused by electric heating, the electrical resistance increase rate of the electrical resistor 1 may be preferably 0.001×10⁻⁶/K or more, more preferably 0.01×10⁻⁶/K or more, and even more preferably 0.1×10-6/K or more. From the perspective that there is an optimum electrical resistance value for electric heating in an electrical circuit, it is ideal that the electrical resistance increase rate of the electrical resistor 1 does not change. From this perspective, the electrical resistance increase rate of the electrical resistor 1 may be preferably 100×10⁻⁶/K or less, more preferably 10×10⁻⁶/K or less, and even more preferably 1×10⁻⁶/K or less.

Further, the electrical resistivity of the electrical resistor 1 is an average value of measured values (n=3) measured by the four-terminal method. In addition, the electrical resistance increase rate of the electrical resistor 1 can be calculated by the following calculation method after measuring the electrical resistivity of the electrical resistor 1 by the method mentioned above. First, the electrical resistivities are measured at three points of 50° C., 200° C. and 400° C. The value derived by subtracting the electrical resistivity at 50° C. from the electrical resistivity at 400° C. is divided by a temperature difference of 350° C. between 400° C. and 50° C. to calculate the electrical resistance increase rate.

The electrical resistor 1 can be produced, for example, as follows, but is not limited to this.

Boric acid, a material containing Si atoms, and kaolin are mixed. Alternatively, borosilicate containing alkali group atoms, material containing Si atoms and kaolin may be mixed. Further, the shape of the borosilicate may be a fiber-shape, particle-shape and the like. From the perspective of improving extrudability of the mixture and the like, the shape of the borosilicate is preferably a fiber-shape. In addition, examples of the material containing Si atoms include, among others, an electroconductive filler containing Si atoms mentioned above. In the above description, in the case of using boric acid, the mass ratio of the boric acid may be, for example, 4 or more and 8 or less. When the mass ratio of boric acid is within the range mentioned above, it is easy to obtain the electrical resistor 1 having a small temperature dependency of electrical resistivity. Further, it becomes easy to increase the content of boron contained in the borosilicate by raising the calcining temperature to be described later. In addition, as the amount of boron doped in the silicate increases, it is advantageous to lower the electrical resistance of the electrical resistor 1.

Next, a binder and water are added to the mixture. Examples of the binder include, among others, an organic binder such as methyl cellulose. In addition, the content of the binder may be, for example, in the order of 2 mass %.

Next, the obtained mixture is molded into a predetermined shape.

Next, the obtained molded body is calcined. Specifically, the calcining conditions may be set, for example, at a calcining temperature of 1150° C. to 1350° C., for a calcining time of 0.1 to 50 hours under an inert gas atmosphere or an air atmosphere at an atmospheric pressure or lower. Further, the calcining atmosphere may be, for example, an inert gas atmosphere, and the calcining pressure may be normal pressure. In order to achieve low electrical resistance of the electrical resistor 1, from the perspective of preventing oxidation, and when performing calcination, it is preferable to reduce residual oxygen gas and to purge inert gas after the inner atmosphere during calcination is set to a state of high vacuum of 1.0×10⁻⁴ Pa or more. Examples of the inert gas atmosphere include, among others, a nitrogen gas atmosphere, a helium gas atmosphere, and an argon gas atmosphere. In addition, prior to calcination mentioned above, the molded body can also be temporarily calcined depending on needs. Specifically, the temporary calcining conditions may include a temporary calcining temperature of 500° C. to 700° C. and a temporary calcining time of 1 to 50 hours under an air atmosphere or an inert gas atmosphere. According to the description mentioned above, the electrical resistor 1 can be obtained.

According to the electrical resistor 1 of the present embodiment, it is possible to realize the electrical resistor 1 where the temperature dependency of the electrical resistivity is small and the electrical resistivity exhibits a PTC characteristic, or the temperature dependency of the electrical resistivity is hardly present. In addition, the electrical resistor 1 of the present embodiment can be composed such that the electrical resistivity does not become any NTC characteristic, and therefore it is possible to avoid current concentration during electric heating. Thus, in the electrical resistor 1 of the present embodiment, a temperature distribution is unlikely to be generated in the interior, and cracks due to a thermal expansion difference are unlikely to occur. Furthermore, the electrical resistor 1 of the present embodiment has an advantage of having low electrical resistance and the smaller temperature dependency of the electrical resistivity compared to a resistor with its entire bulk composed of the matrix 10 mentioned above, SiC and the like.

### Embodiment 2

An electrical resistor of Embodiment 2 shall be described with reference to FIG. 2. Further, among the reference signs used in Embodiment 2 and onwards, the same reference signs as those used in the embodiment already described above represent the same components as those in the embodiment already described above unless otherwise indicated.

As illustrated in FIG. 2, an electrical resistor 1 of the present embodiment differs from that of Embodiment 1 in that the electrical resistor 1 of the present embodiment, unlike that of Embodiment 1, contains another substance besides a matrix 10, and that the “another substance” is a non-electroconductive filler 12. According to this composition, by compounding the matrix 10 and the non-electroconductive filler 12, the electrical resistivity of the matrix 10 and the electrical resistivity of the non-electroconductive filler 12 are added together, and the electrical resistivity of the entire electrical resistor 1 is determined. Thus, according to this composition, the electrical resistivity of the electrical resistor 1 can be controlled by adjusting the content of the non-electroconductive filler 12 and the like.

Specifically, the non-electroconductive filler 12 preferably contains Si atoms. According to this composition, when a raw material containing borosilicate and the non-electroconductive filler 12 is sintered to produce the electrical resistor 1, the Si atoms of the non-electroconductive filler 12 diffuse into the borosilicate, and silicon enrichment of the borosilicate is promoted and the softening point of the matrix 10 can be improved. Therefore, according to this composition, it is possible to improve the shape retention of the electrical resistor 1, and the electrical resistor 1 that is useful as a material for the structure can be obtained.

The non-electroconductive filler 12 containing Si atoms is not particularly limited as long as Si atoms can be diffused into the borosilicate, and examples thereof include, among others, SiO₂ particles and Si₃N₄ particles. These particles may be used alone or in combination of two or more kinds. In addition, the electrical resistor 1 specifically may be of a composition containing a total of 50 vol % or more of the matrix 10 and the non-electroconductive filler 12.

Other compositions and functional effects are basically the same as those of the Embodiment 1.

### Embodiment 3

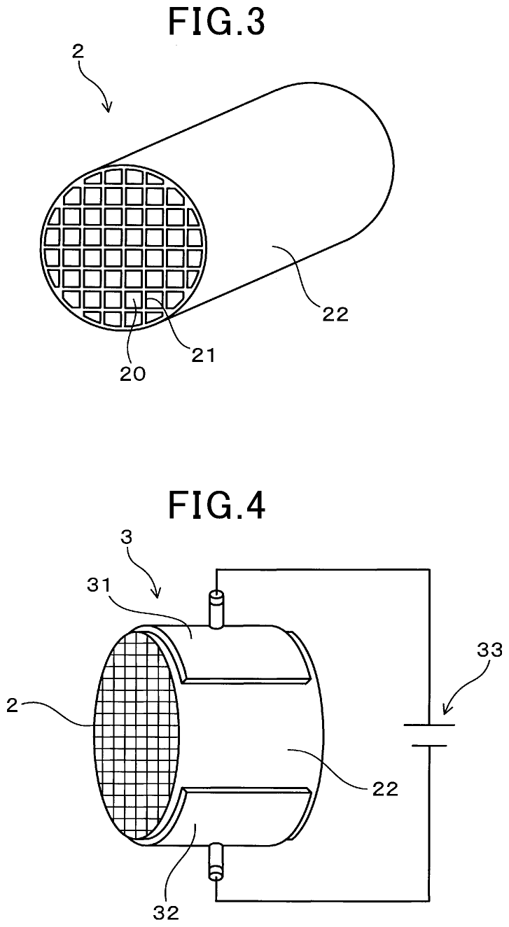

A honeycomb structure of Embodiment 3 will be described with reference to FIG. 3. As illustrated in FIG. 3, a honeycomb structure 2 of the present embodiment comprises the electrical resistor 1 of the Embodiment 1. In the present embodiment, specifically, the honeycomb structure 2 is composed of the electrical resistor 1 of the Embodiment 1. Specifically, in a honeycomb cross-sectional view perpendicular to the central axis of the honeycomb structure 2, FIG. 3 illustrates a structure having a plurality of cells 20 adjacent to one another, cell walls 21 forming the cells 20, and an outer peripheral wall 22 provided in the outer peripheral portion of cell walls 21 and retains the cell walls 21 in one piece. Further, a publicly known structure can be applied to the honeycomb structure 1, and it is not limited to the structure of FIG. 3. Although FIG. 3 shows an example where each cell 20 has a square cross section, the cell 20 may have a hexagonal cross section.

The honeycomb structure 2 of the present embodiment comprises the electrical resistor 1 of the present embodiment. Therefore, in the honeycomb structure 2 of the present embodiment, a temperature distribution is unlikely to be generated in the interior of the structure during electric heating, and cracks due to a thermal expansion difference are unlikely to occur. In addition, the honeycomb structure 2 of the present embodiment uses the electrical resistor 1 of the present embodiment, and therefore it can be heated at a lower temperature and in an early period during electric heating.

### Embodiment 4

An electrically heated catalyst device of Embodiment 4 will be illustrated with reference to FIG. 4. As illustrated in FIG. 4, an electrically heated catalyst device 3 of the present embodiment comprises the honeycomb structure 2 of the Embodiment 3. In the present embodiment, specifically, the electrically heated catalyst device 3 comprises the honeycomb structure 2, a three-way catalyst (not shown in the figure) supported in the cell walls 21 of the honeycomb structure 2, a pair of electrodes 31 and 32 arranged facing each other in the outer peripheral wall 22 of the honeycomb structure 2, and a voltage application unit 33 that applies voltage to the electrodes 31 and 32. Further, a publicly known structure can be applied to the electrically heated catalyst device 3, and the structure is not limited to that of FIG. 4.

The electrically heated catalyst device 3 of the present embodiment has the honeycomb structure 2 of the present embodiment. Therefore, in the electrically heated catalyst device 3 of the present embodiment, the honeycomb structure 2 is unlikely to crack during electric heating, and its reliability can be improved. In addition, the electrically heated catalyst device 3 of the present embodiment uses the honeycomb structure 2 of the present embodiment, and therefore the honeycomb structure 2 mentioned above can be heated at a lower temperature and in an early period during electric heating, and it is advantageous for early catalyst activation.

### Experimental Examples

### Experimental Example 1

### [Sample 1]

Borosilicate glass particles containing Na, Mg, K and Ca, and Si particles were mixed at a mass ratio of 48:52. Next, 2 mass % of methylcellulose as a binder was added to the mixture, water was further added thereto, and the mixture was kneaded. Next, the obtained mixture was molded into pellets with an extrusion molding machine and the pellets were subjected to primary calcining. The conditions for the primary calcining were as follows: a calcining temperature of 700° C., a temperature elevation rate of 100° C./hour, a holding time of 1 hour under air atmosphere and normal pressure. Next, the calcined body subjected to primary calcining was subjected to secondary calcining. The conditions for the secondary calcining were as follows: a calcining temperature of 1300° C., a calcining time of 30 minutes, a temperature elevation rate of 200° C./hour under N₂ gas atmosphere and normal pressure. As a result, sample 1 having a shape of 5 mm×5 mm×18 mm was obtained. According to an EPMA measurement, matrix in sample 1 contained a total of 2.9 mass % of alkali group atoms (Na, Mg, K and Ca), 24.7 mass % of Si, 69.5 mass % of O and 1.1 mass % of Al. In addition, according to an ICP measurement, the matrix in sample 1 contained 0.8 mass % of B. As for the EPMA analyzer, “JXA-8500F” manufactured by JEOL Ltd. was used. In addition, as for the ICP analyzer, “SPS-3520UV” manufactured by Hitachi High-Tech Science Corporation was used. The same applies hereafter.

### [Sample 2]

Sample 2 was obtained in the same manner as that of preparing sample 1, except that borosilicate glass particles, Si particles, and kaolin were mixed at a mass ratio of 29:31:40. Further, according to the EPMA measurement, a matrix in sample 2 contained a total of 2.4 mass % of alkali group atoms (Na, Mg, K and Ca), 22.7 mass % of Si, 68.1 mass % of 0 and 5.4 mass % of Al. In addition, according to the ICP measurement, the matrix in sample 2 contained 0.6 mass % of B.

### [Sample 1C]

SiC was determined as sample 1C.

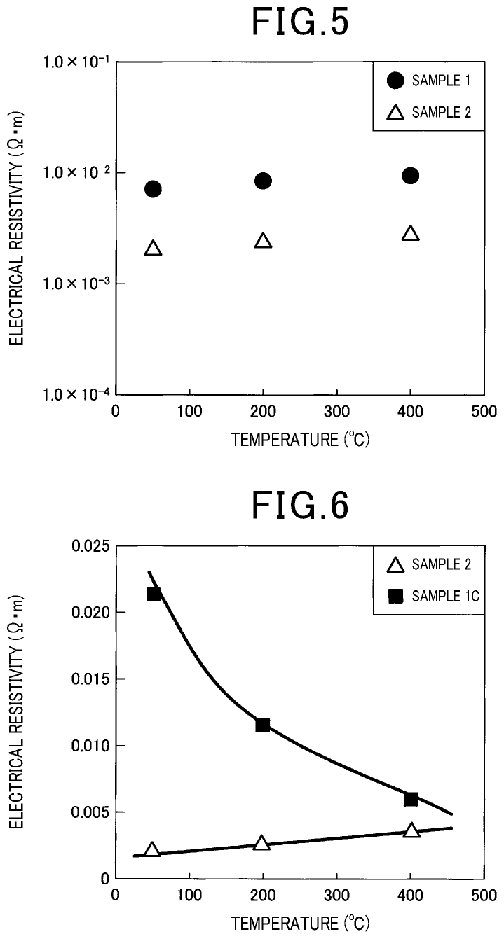

Electrical resistivity was measured for each of the obtained samples. Further, the electrical resistivity was measured for a 5 mm×5 mm×18 mm prism sample by the four-terminal method with a thermoelectrical property evaluation device (“ZEM-2” manufactured by ULVAC-RIKO INC.). As shown in FIG. 5 and FIG. 6, it can be understood that each of sample 1 and sample 2 has a significantly smaller temperature dependency of electrical resistivity compared to that of SiC of sample 1C, and that the electrical resistivity exhibits a PTC characteristic. In addition, it can also be understood that each of sample 1 and sample 2 has a smaller electrical resistivity in the measured temperature range than that of SiC of sample 1C. In addition, it can also be understood according to sample 1 that the electrical resistivity exhibits a PTC characteristic without using kaolin. Further, it can be understood that each of sample 1 and sample 2 has an electrical resistivity in a range of 0.0001 Ω·m or more and 1 Ω·m or less, and an electrical resistance increase rate in a range of 0.01×10⁻⁶/K or more and 5.0×10⁻⁴/K or less in a temperature range from 25° C. to 500° C.

### Experimental Example 2

### [Sample 3]

Borosilicate glass particles containing Na, Mg, K and Ca, Si particles, and kaolin were mixed at a mass ratio of 29:31:40. Next, 0.4 mass % of sodium carbonate (Na₂CO₃) and 2 mass % of methylcellulose as a binder were added to this mixture, water was further added thereto, and the mixture was kneaded. Next, the obtained mixture was molded into pellets with an extrusion molding machine and the pellets were calcined. The calcining conditions were as follows: a calcining temperature of 1300° C., a calcining time of 30 minutes, a temperature elevation rate of 200° C./hour under an argon gas atmosphere and atmospheric pressure. As a result, sample 3 having a shape of 5 mm×5 mm×18 mm was obtained. According to the EPMA measurement, a matrix in sample 3 contained a total of 3.1 mass % of alkali group atoms (Na, Mg, K and Ca), 22.3 mass % of Si, 67.7 mass % of 0, and 5.3 mass % of Al. In addition, according to the ICP measurement, the matrix in sample 3 contained 0.6 mass % of B.

### [Sample 4]

Sample 4 was obtained in the same manner as that of preparing sample 3, except that the amount of sodium carbonate added was 0.8 mass %. According to the EPMA measurement, a matrix in sample 4 contained a total of 3.5 mass % of alkali group atoms (Na, Mg, K and Ca), 22.4 mass % of Si, 66.7 mass % of 0, and 5.5 mass % of Al. In addition, according to the ICP measurement, a matrix in sample 4 contained 0.6 mass % of B.

### [Sample 5]

Sample 5 was obtained in the same manner as that of preparing sample 3, except that sodium carbonate was not added. According to the EPMA measurement, a matrix in the sample 5 contained a total of 2.4 mass % of alkali group atoms (Na, Mg, K and Ca), 22.7 mass % of Si, 68.1 mass % of 0 and 5.7 mass % of Al. In addition, according to the ICP measurement, a matrix in sample 5 contained 0.6 mass % of B.

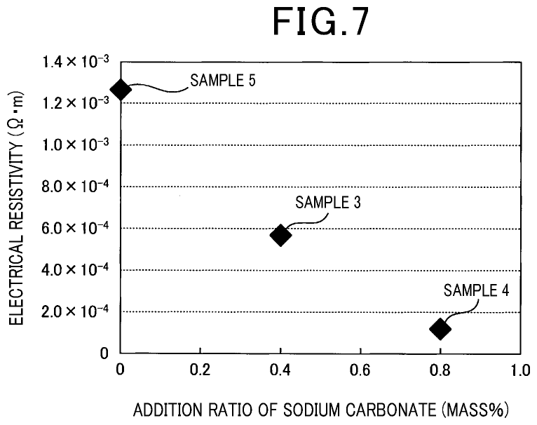

Electrical resistivity of each of the obtained samples at room temperature was measured. As shown in FIG. 7, the electrical resistivity of each of the samples was reduced by adding a compound containing alkali group atoms such as sodium carbonate. The reason that the electrical resistivity of each sample was reduced by adding a compound containing alkali group atoms is considered to be that oxidation of Si particles was suppressed. Further, it was confirmed that the total content of alkali group atoms in sample 3 and sample 4, where sodium carbonate was added, increased as compared to sample 5 where sodium carbonate was not added. This is because Na atoms were doped in the borosilicate glass used as a raw material by adding sodium carbonate, and the total content of alkali group atoms increased.

### Experimental Example 3

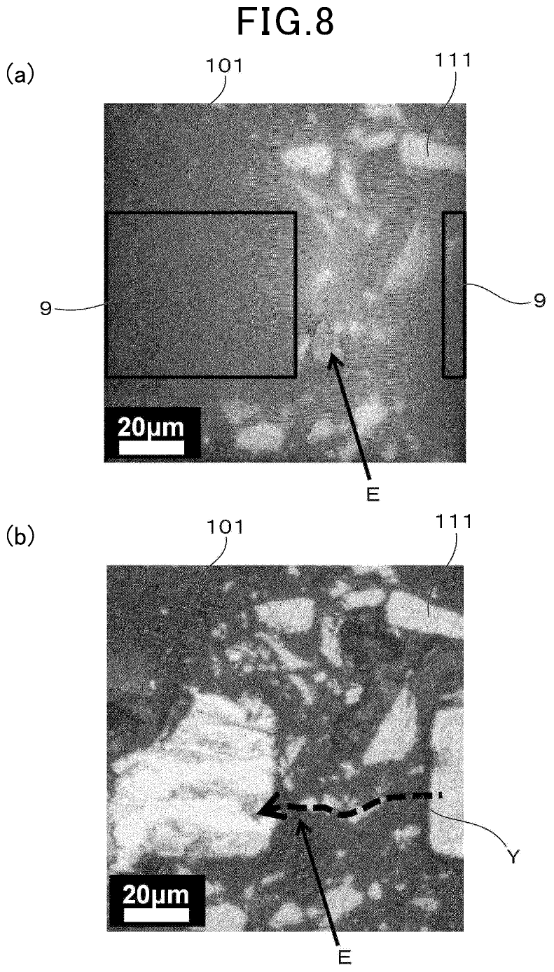

Using sample 2 mentioned above, an experiment for specifying an electroconductive portion in sample 2 was performed. Specifically, a pair of Au electrode pads 9 were attached to the surface of sample 2, which was subjected to electric heating, and an atom mapping image of aluminum around the Au electrode pads 9 (FIG. 8 (a)) was obtained using an emission microscope (“PHEMOS-1000” manufactured by Hamamatsu Photonics K.K.). In the atom mapping image mentioned above, the color of the region heated by electric heating (emission part E) is shown to be changed. In addition, FIG. 8 (b) shows an optical microscope image around the emission part E in sample 2. In FIG. 8, reference sign 101 denotes a matrix, and reference sign 111 denotes Si particles. In addition, an arrow Y denotes an estimated electroconductive path.

According to FIG. 8, it can be understood that electrons are flowing through Si and the matrix. In addition, it can be understood that heat is not generated in the Si region, but is generated in the portion of the matrix composed of borosilicate glass. From this result, it was confirmed that the region that controls the electrical resistance during electric heating is the matrix that is a base material.

### Experimental Example 4

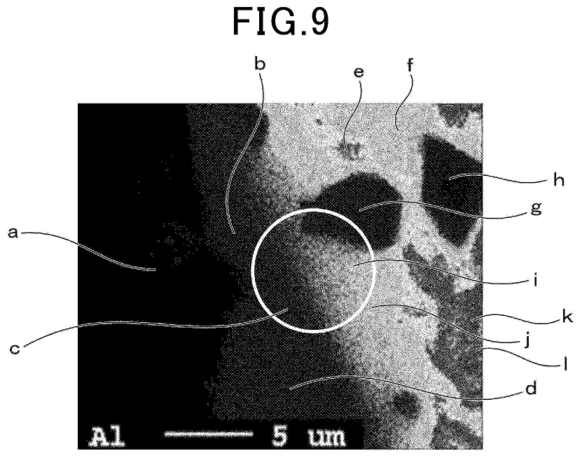

In order to study in detail the composition of the emission part in sample 2 of [Experimental Example 3] mentioned above, an atom mapping image around the emission part was obtained by the EPMA measurement. FIG. 9 shows an atom mapping image of aluminum around the emission part of sample 2. Further, in FIG. 9, the circled part is the emission part. In addition, chemical compositions in regions indicated by reference signs “a” to “I” in FIG. 9 were measured. The results are shown in Table 1. Further, the part denoted by reference sign “a” is an electrode.

TABLE 1

| | Chemical Compositions (mass %) | | | | | | | | | |
|---|---|---|---|---|---|---|---|---|---|---|
| Regions | B | C | O | Na | Mg | Al | Si | K | Ca | Fe |
| a (Electrode) | — | 13.3 | — | — | — | — | — | — | — | 68.2 |
| b | — | — | 80.0 | — | 0.2 | 1.5 | 18.2 | 0.1 | 0.1 | 0.1 |
| c | 7.5 | — | 74.4 | — | — | 0.8 | 17.3 | — | — | — |
| d | 7.5 | — | 75.7 | — | — | 0.6 | 16.2 | — | — | — |
| e | — | 3.6 | 69.9 | — | 0.2 | 3.9 | 20.9 | 0.4 | 0.1 | 0.2 |
| f | — | — | 76.1 | — | 0.2 | 4.2 | 18.9 | 0.3 | 0.1 | 0.1 |
| g | — | 17.5 | 11.5 | — | — | 1.0 | 69.5 | 0.2 | — | 0.3 |
| h | — | 20.4 | 8.5 | — | — | 0.6 | 70.5 | — | — | — |
| i | — | — | 77.8 | — | 0.3 | 2.9 | 18.7 | 0.3 | 0.2 | — |
| j | — | — | 79.3 | — | 0.3 | 2.9 | 17.2 | 0.1 | 0.2 | — |
| k | — | 2.6 | 73.8 | — | 0.4 | 6.8 | 15.4 | 0.2 | 0.1 | 0.5 |
| l | — | 2.1 | 74.6 | — | 0.3 | 8.8 | 13.8 | 0.2 | 0.1 | 0.1 |

As shown in Table 1, according to this experiment, region “i” and region “j” corresponding to the emission parts were aluminosilicates. In addition, region “b”, region “e”, region “f”, region “k”, and region “I” were also aluminosilicates. Region “c” and region “d” were borosilicate glass. Region “g” and region “h” were silicon. However, according to another Experimental Example 5, it was revealed that region “i” and region “j” corresponding to the emission parts contain B. Therefore, it was considered that region “i” and region “j” corresponding to the emission parts were aluminoborosilicate. However, detection sensitivity of boron is low in the EPMA, and therefore boron may not be detected. In addition, a large amount of Fe was detected in region “a”, it was considered that this is because a point where Fe was segregated was measured.

### Experimental Example 5

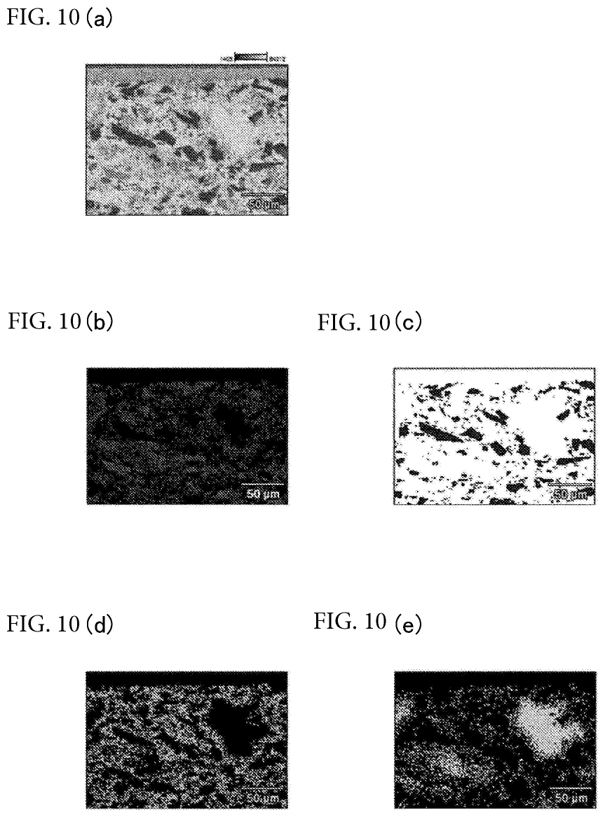

Composition analysis by SEM-EDX was performed on sample 2 of [Experimental Example 3] mentioned above. The results are shown in FIGS. 10(a)-(e). FIG. 10 (a) shows a base region to be subjected to a composition analysis. FIG. 10 (b) shows a region having a composition ratio of Phase 1 shown in Table 2 or a region having almost the same composition ratio. FIG. 10 (c) shows a region having a composition ratio of Phase 2 shown in Table 2 or a region having almost the same composition ratio. FIG. 10 (d) shows a region having a composition ratio of Phase 5 shown in Table 2 or a region having almost the same composition ratio. FIG. 10 (e) shows a region having a composition ratio of Phase 6 shown in Table 2 or a region having almost the same composition ratio. It can be understood that Phase 2 is an Si portion, and Phases 1, 5 and 6 are matrix portions. From the results of this experiment, it can be understood that the matrix portion is composed of aluminoborosilicate containing at least one kind selected from the group consisting of Na, Mg, K and Ca, and that the aluminoborosilicate contains in ranges of a total of 0.01 mass % or more and 10 mass % or less of alkali group atoms, 0.1 mass % or more and 5 mass % or less of B atoms, 5 mass % or more and 40 mass % or less of Si atoms, 40 mass % or more and 85 mass % or less of 0 atoms, and 0.5 mass % or more and 10 mass % or less of Al atoms. The reason that the matrix portion became aluminoborosilicate containing alkali group atoms is that kaolin is used as a raw material. Thus, in the case where kaolin is not used as a raw material, it can be said that the matrix portion becomes borosilicate containing alkali group atoms.

TABLE 2

| | Chemical Compositions (mass %) | | | | | | | | | |
|---|---|---|---|---|---|---|---|---|---|---|
| | B | C | O | Na | Mg | Al | Si | K | Ca | Fe |
| Phase 1 | 0.66 | 1.35 | 64.5 | 1.28 | 0.34 | 2.09 | 29.67 | 0.01 | 0.12 | 0 |
| Phase 2 | 1.03 | 2.25 | 7.11 | 0.19 | 0.02 | 0.45 | 87.63 | 0 | 0 | 1.3 |
| Phase 5 | 0.76 | 1.51 | 60.5 | 3.12 | 0.74 | 3.98 | 28.33 | 0.21 | 0.29 | 0.56 |
| Phase 6 | 1.55 | 1.87 | 66.93 | 1.76 | 0.34 | 2.37 | 24.45 | 0.06 | 0.03 | 0.65 |

### Experimental Example 6

### [Sample 6]

Borosilicate glass fibers containing Na, Mg, K and Ca, Si particles, and kaolin were mixed at a mass ratio of 29:31:40. Further, the borosilicate glass fibers (having an average diameter of 10 μm, and an average length of 25 μm) used in this experimental example contain more Ca than the borosilicate glass particles used in each of the experimental examples mentioned above. Next, 2 mass % of methylcellulose as a binder was added to the mixture, water was further added thereto, and the mixture was kneaded. Next, the obtained mixture was molded into pellets with an extrusion molding machine and the pellets were subjected to primary calcining. The conditions for the primary calcining were as follows: a calcining temperature of 700° C., a temperature elevation time of 100° C./hour, a holding time of 1 hour under air atmosphere and normal pressure. Next, the calcined body subjected to primary calcining was subjected to secondary calcining. The conditions for the secondary calcining were as follows: a calcining temperature of 1300° C., a calcining time of 30 minutes, a temperature elevation rate of 200° C./hour under N₂ gas atmosphere and normal pressure. As a result, sample 6 having a shape of 5 mm×5 mm×18 mm was obtained. According to the EPMA measurement, matrix in sample 6 contained a total of 6.4 mass % of alkali group atoms (Na, Mg, K and Ca), 21.4 mass % of Si, 65.4 mass % of 0 and 5.1 mass % of Al. In addition, according to the ICP measurement, the matrix in sample 6 contained 0.8 mass % of B.

### [Sample 7]

Boric acid, Si particles, and kaolin were mixed at a mass ratio of 4:42:54. Next, 2 mass % of methylcellulose as a binder was added to the mixture, water was further added thereto, and the mixture was kneaded. Next, the obtained mixture was molded into pellets with an extrusion molding machine and the pellets were subjected to primary calcining. The conditions for the primary calcining were as follows: a calcining temperature of 700° C., a temperature elevation time of 100° C./hour, a holding time of 1 hour under air atmosphere and normal pressure. Next, the calcined body subjected to primary calcining was subjected to secondary calcining. The conditions for the secondary calcining were as follows: a calcining temperature of 1250° C., a calcining time of 30 minutes, a temperature elevation rate of 200° C./hour under N₂ gas atmosphere and normal pressure. As a result, sample 7 having a shape of 5 mm×5 mm×18 mm was obtained. According to the EPMA measurement, matrix in sample 7 contained a total of 0.5 mass % of alkali group atoms (Na, Mg, K and Ca), 22.7 mass % of Si, 68.1 mass % of 0 and 5.7 mass % of Al. In addition, according to the ICP measurement, the matrix in sample 7 contained 0.9 mass % of B.

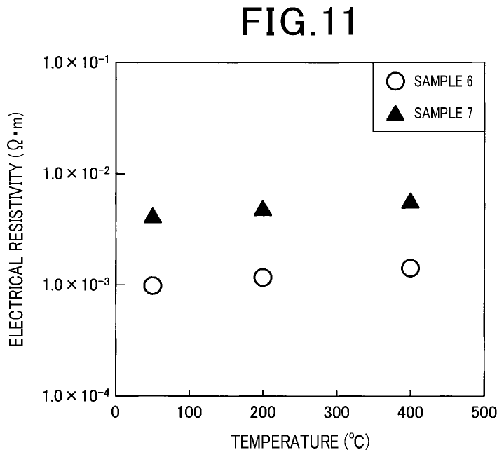

Electrical resistivity was measured for each of the obtained samples in the same manner as that adopted in Experimental Example 1. As shown in FIG. 11, it can be understood that each of sample 6 and sample 7 has a significantly smaller temperature dependency of electrical resistivity compared to that of SiC of sample 1C mentioned above in Experimental Example 1, and that the electrical resistivity exhibits a PTC characteristic. In addition, it can be understood that each of sample 6 and sample 7 has an electrical resistivity of 0.0001 Ω·m or more and 1 Ω·m or less, and an electrical resistance increase rate of 0.01×10⁻⁶/K or more and 5.0×10⁻⁴/K or less in a temperature range from 25° C. to 500° C. Further, despite being calcined at a lower temperature compared to sample 6, sample 7 has predetermined characteristics. In the case where the calcining temperature of sample 7 is made equal to that of sample 6, doping of boron (B) into aluminoborosilicate, which is the matrix in sample 7, is facilitated, and it is supposed that the electrical resistivity can be further reduced. This point shall be described later in Experimental Example 7.

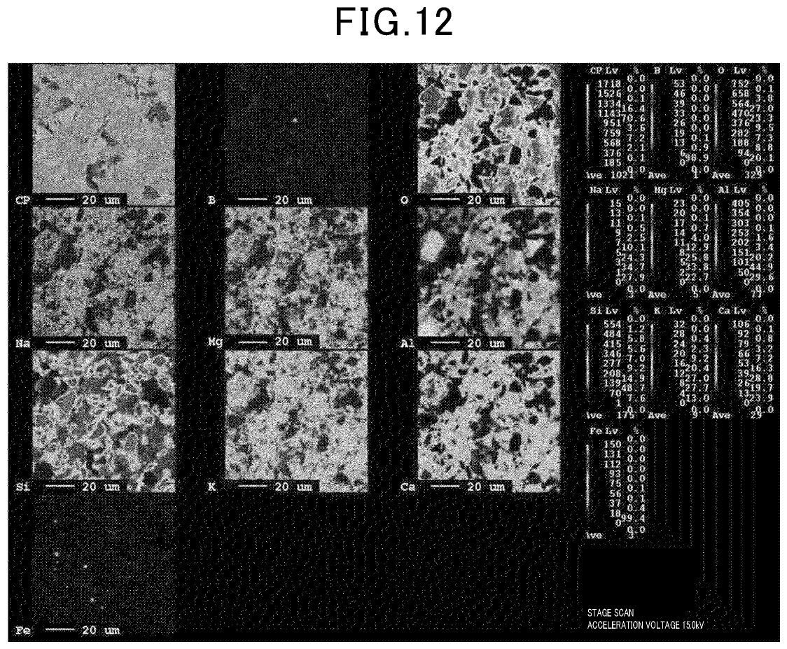

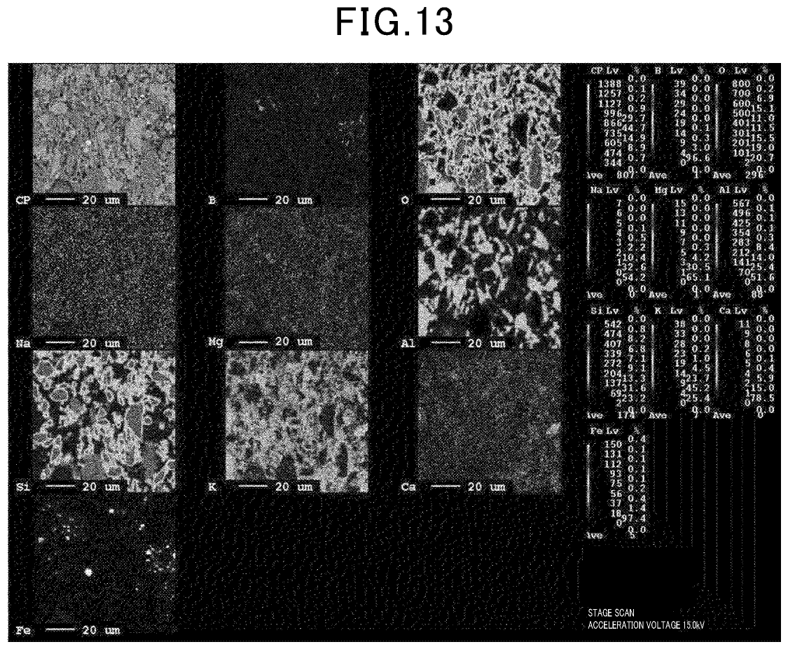

Next, the EPMA measurement was performed on a material cross section of each sample. The results are shown in FIG. 12 and FIG. 13. As shown in FIG. 12, it can be understood that sample 6 using borosilicate glass as a raw material had many alkali group atoms such as Na, Mg, K and Ca, and O atoms on the material surface. That is, sample 6 used borosilicate glass containing a large amount of alkali group atoms as a raw material, and therefore it can be understood that alkali group atoms eluted on the surface of the material reacted with oxygen, and that an insulating glass film was formed on the surface of the material.

On the other hand, as shown in FIG. 13, sample 7 used boric acid as a raw material and the content of alkali group atoms contained in the raw material was actively reduced. Therefore, it can be understood that the amount of alkali group atoms such as Na, Mg, K and Ca, and O atoms on the material surface was drastically reduced compared to the amount of those in sample 6. That is, sample 7 used boric acid, which did not contain alkali group atoms, as a raw material, and therefore it can be understood that a phenomenon of forming an insulating glass film on the material surface could not be suppressed. Further, a slight amount of K was detected on the material surface of sample 7, but an insulating glass film was not formed.

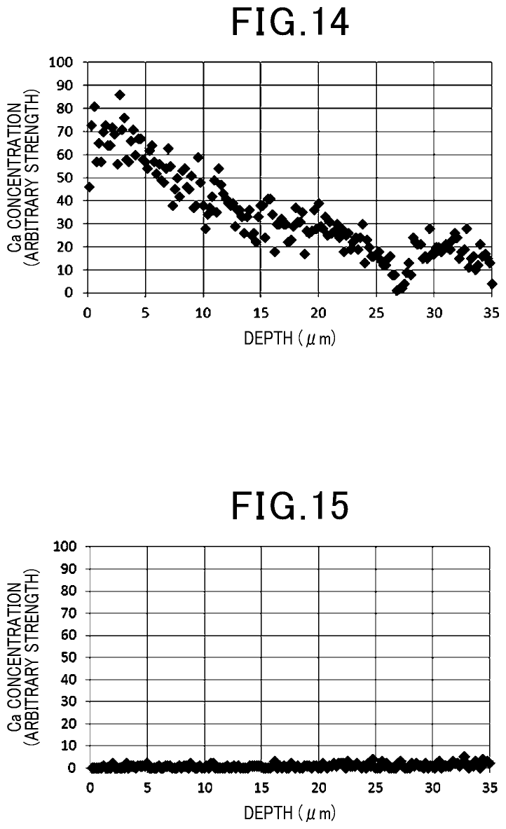

Next, a line profile of Ca in the depth direction from the material surface of each sample was measured. The results are shown in FIG. 14 and FIG. 15. As shown in FIG. 14, it can be understood that sample 6 has a high Ca concentration on the material surface caused by Ca eluted and segregated on the material surface side. On the other hand, in sample 7, changes in the Ca concentration on the material surface and in the material interior were both hardly recognized. From these results, in the borosilicate containing at least one kind of alkali group atoms selected from the group consisting of Na, Mg, K and Ca, it was confirmed that, by controlling the total content of the alkali group atoms to 2 mass % or less, an electrical resistor hardly having an insulating glass film on the surface can be obtained without forming a gas barrier film that blocks oxygen gas when calcining under an atmosphere containing oxygen gas. Further, in this experimental example, since there was a big difference in the Ca concentration between sample 6 and sample 7 due to the difference in a boron supply source, Ca was selected as an example of the alkali group atoms in FIG. 14 and FIG. 15. However, from the results mentioned above, it can be easily presumed that a same trend as mentioned above will be exhibited for other alkali group atoms as well.

### Experimental Example 7

### [Sample 8]

Sample 8 was obtained in the same manner as that of preparing sample 7 of Experimental Example 6, except that boric acid, Si particles, and kaolin were mixed at a mass ratio of 6:41:53, and that the calcining temperature was 1250° C. According to the EPMA measurement, a matrix in sample 8 contained a total of 0.5 mass % of alkali group atoms, 23.6 mass % of Si, 66.8 mass % of 0, and 5.8 mass % of Al. In addition, according to the ICP measurement, the matrix in sample 8 contained 1.3 mass % of B.

### [Sample 9]

Sample 9 was obtained in the same manner as that of preparing sample 7 of Experimental Example 6, except that boric acid, Si particles, and kaolin were mixed at a mass ratio of 8:40:52, and that the calcining temperature was 1250° C. According to the EPMA measurement, a matrix in sample 9 contained a total of 0.4 mass % of alkali group atoms, 23.9 mass % of Si, 66.1 mass % of 0, and 5.6 mass % of Al. In addition, according to the ICP measurement, the matrix in sample 9 contained 2.1 mass % of B.

### [Sample 10]

Sample 10 was obtained in the same manner as that of preparing sample 7 of Experimental Example 6, except that boric acid, Si particles, and kaolin were mixed at a mass ratio of 4:42:54, and that the calcining temperature was 1300° C. According to the EPMA measurement, a matrix in sample 10 contained a total of 0.4 mass % of alkali group atoms, 24.1 mass % of Si, 65.9 mass % of 0, and 5.9 mass % of Al. In addition, according to the ICP measurement, the matrix in sample 10 contained 0.9 mass % of B.

### [Sample 11]

Sample 11 was obtained in the same manner as that of preparing sample 7 of Experimental Example 6, except that boric acid, Si particles, and kaolin were mixed at a mass ratio of 6:41:53, and that the calcining temperature was 1300° C. According to the EPMA measurement, a matrix in sample 11 contained a total of 0.4 mass % of alkali group atoms, 23.0 mass % of Si, 67.1 mass % of 0, and 5.5 mass % of Al. In addition, according to the ICP measurement, the matrix in sample 11 contained 1.4 mass % of B.

### [Sample 12]

Sample 12 was obtained in the same manner as that of preparing sample 7 of Experimental Example 6, except that boric acid, Si particles, and kaolin were mixed at a mass ratio of 8:40:52, and that the calcining temperature was 1300° C. According to the EPMA measurement, a matrix in sample 12 contained a total of 0.4 mass % of alkali group atoms, 22.8 mass % of Si, 68.2 mass % of 0, and 5.4 mass % of Al. In addition, according to the ICP measurement, the matrix in sample 12 contained 2.0 mass % of B.

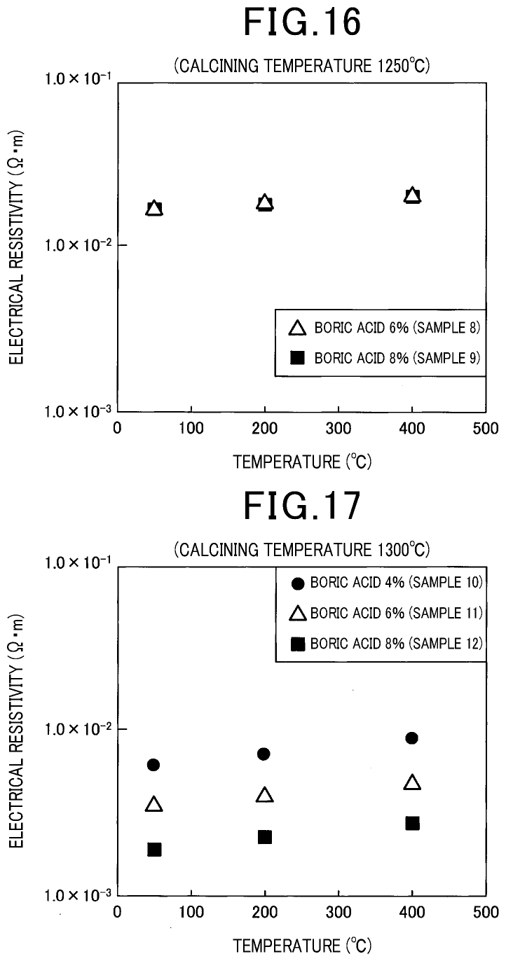

Electrical resistivity was measured for each of the obtained samples in the same manner as that adopted in Experimental Example 1. The results are shown in FIG. 16 and FIG. 17. As shown in FIG. 16 and FIG. 17, it was confirmed that, as the calcining temperature rose, and as the charged amount of boric acid increased, boron doping into the aluminosilicate was promoted and the electrical resistivity decreased.

According to each of the experimental results mentioned above, the followings can be said by using borosilicate containing at least one kind or more of alkali group atoms such as Na, Mg, K and Ca as a matrix of an electrical resistor. According to the electrical resistor mentioned above, the region that controls electrical resistance during electric heating is the matrix that is a base material. In the matrix mentioned above, temperature dependency of the electrical resistivity is smaller compared to that of SiC, and the electrical resistivity exhibits a PTC characteristic. Therefore, in the case where the electrical resistivity of another substance different from the matrix that can be contained in the electrical resistor exhibits a PTC characteristic, the electrical resistivity of the electrical resistor can be composed so as to have a small temperature dependency and to exhibit a PTC characteristic. On the other hand, in the case where the electrical resistivity of the another substance exhibits a NTC characteristic, it is possible to design an electrical resistivity of an electrical resistor that has a small temperature dependency and that exhibits a PTC characteristic, or that hardly has a temperature dependency by adding together the electrical resistivity of a matrix exhibiting a PTC characteristic and the electrical resistivity of the another substance exhibiting NTC characteristic. Therefore, by adopting the matrix mentioned above, it is possible to obtain an electrical resistor where the temperature dependency of the electrical resistivity is small, and the electrical resistivity exhibits PTC characteristic, or the temperature dependency of the electrical resistivity is hardly present. In addition, the electrical resistor can be composed so that the electrical resistivity does not exhibit any NTC characteristic, and therefore it is possible to avoid current concentration during electric heating. Thus, it is possible to obtain an electrical resistor where a temperature distribution is unlikely to be generated in the interior, and cracks due to a thermal expansion difference are unlikely to occur. Furthermore, in the electrical resistivity mentioned above, it is possible to facilitate low electrical resistance of a matrix by adopting the matrix mentioned above, and it is possible to obtain an electrical resistor with a small temperature dependency of electrical resistivity.

The present disclosure is not limited to each of the embodiments and each of the experimental examples mentioned above, and various modifications can be made without departing from the scope of the disclosure. In addition, each composition shown in each of the embodiments and each of the experimental examples can be optionally combined. That is, although the present disclosure is described based on the embodiments, it is understood that the present disclosure is not limited to the embodiments, compositions and the like. The present disclosure includes various modification examples and modifications within equivalent scopes. In addition, various combinations and aspects, as well as other combinations and aspects including only one element, or more or less than one element, are within the scope and idea of the present disclosure. For example, in Embodiment 3, an example of a honeycomb structure composed of an electrical resistor of Embodiment 1 was described, but a honeycomb structure can also be composed of an electrical resistor of Embodiment 2. In addition, in Embodiment 4, an example of applying a honeycomb structure of Embodiment 3 was described, but an electrically heated catalyst device may apply a honeycomb structure composed of an electrical resistor of Embodiment 2.

What is claimed is:

1. An electrical resistor comprising a matrix composed of borosilicate containing at least one kind of alkali group atoms selected from the group consisting of Na, Mg, K, Ca, Li, Be, Rb, Sr, Cs, Ba, Fr, and Ra, the electrical resistor having, in a temperature range from 25° C. to 500° C., an electrical resistivity in the range of 0.0001 Ω·m or more and 1 Ω·m or less and an electrical resistance increase rate in the range of 0.01×10⁻⁶/K or more and 5.0×10⁻⁴/K or less, or an electrical resistivity in the range of 0.0001 Ω·m or more and 1 Ω·m or less and an electrical resistance increase rate in the range of 0 or more and less than 0.01×10⁻⁶/K.

2. The electrical resistor according to claim 1 composed so as to be used in a honeycomb structure in an electrically heated catalyst device.

3. An electrical resistor comprising a matrix composed of borosilicate containing at least one kind of alkali group atoms selected from the group consisting of Na, Mg, K, Ca, Li, Be, Rb, Sr, Cs, Ba, Fr, and Ra, the electrical resistor being composed so as to be used in a honeycomb structure in an electrically heated catalyst device.

4. The electrical resistor according to claim 3 having, in a temperature range from 25° C. to 500° C., an electrical resistivity in the range of 0.0001 Ω·m or more and 1 Ω·m or less and an electrical resistance increase rate in the range of 0.01×10⁻⁶/K or more and 5.0×10⁻⁴/K or less, or an electrical resistivity in the range of 0.0001 Ω·m or more and 1 Ω·m or less and an electrical resistance increase rate in the range of 0 or more and less than 0.01×10⁻⁶/K.

5. The electrical resistor according to claim 1, wherein the content of B atoms in the borosilicate is 0.1 mass % or more and 5 mass % or less.

6. The electrical resistor according to claim 1, wherein the total content of the alkali group atoms in the borosilicate is 10 mass % or less.

7. The electrical resistor according to claim 1, wherein the borosilicate contains, as the alkali group atoms, at least one kind of atoms alkali group atoms selected from the group consisting of Na, Mg, K and Ca, and the total content of the alkali group atoms is 2 mass % or less.

8. The electrical resistor according to claim 1, wherein the total content of the alkali group atoms in the borosilicate is 0.01 mass % or more.

9. The electrical resistor according to claim 1, wherein the content of Si atoms in the borosilicate is 5 mass % or more and 40 mass % or less.

10. The electrical resistor according to claim 1, wherein the content of 0 atoms in the borosilicate is 40 mass % or more and 85 mass % or less.

11. The electrical resistor according to claim 1, wherein the borosilicate is aluminoborosilicate.

12. The electrical resistor according to claim 11, wherein the content of Al atoms in the aluminoborosilicate is 0.5 mass % or more and 10 mass % or less.

13. The electrical resistor according to claim 1 further comprising an electroconductive filler.

14. The electrical resistor according to claim 13, wherein the electroconductive filler contains Si atoms.

15. The electrical resistor according to claim 13 containing the matrix and the electroconductive filler in a total of 50 vol % or more.

16. A honeycomb structure comprising the electrical resistor according to claim 1.

17. An electrically heated catalyst device having the honeycomb structure according to claim 16.

18. An electrically heated catalyst device having a honeycomb structure comprising an electrical resistor, the electrical resistor comprising a matrix composed of borosilicate containing at least one kind of alkali group atoms selected from the group consisting of Na, Mg, K, Ca, Li, Be, Rb, Sr, Cs, Ba, Fr, and Ra.
